(19) United States
(12) Patent Application Publication
(10) Pub. No.: US 2010/0011971 A1
(43) Pub. Date: Jan. 21, 2010

(54) STOCK POT COOKER

(76) Inventor: Robert S. Babington, McLean, VA (US)

Correspondence Address: CONNOLLY BOVE LODGE & HUTZ, LLP, P O BOX 2207, WILMINGTON, DE, 19899, US

(21) Appl. No.: 12/173,895

(22) Filed: Jul. 16, 2008

(51) Int. Cl. A47J 37/00

(52) U.S. Cl. 99/340

(57) ABSTRACT

A stock pot cooker is disclosed. A firebox includes a burner receptacle on a first side, a stock pot receptacle on a second side, and an exhaust port, with each being fluidically connected to a heat plenum formed within the firebox. The stock pot receptacle includes a seating surface configured to seat a stock pot having a predetermined size. When a stock pot is seated, excess heat from the heat plenum is directed through the exhaust port.

### BACKGROUND OF THE INVENTION

1. Field of the Invention

The field of the present invention is heating appliances for cooking, particularly those heating appliances adapted to heat and cook food within a stock pot.

2. Background

Stock pots are commonly found in almost every kitchen and are frequently used for preparing soup and many other types of food. During the typical cooking process, the stock pot is placed on a burner over an open flame. While this method of cooking food in a stock pot works quite well, as has been proven over time, it has certain inefficiencies which, if overcome, would reduce the amount of time needed to cook any given type of food. Reducing the amount of cooking time is especially important when the cooking is being done in the field for troops or in an emergency response situation where hundreds, or even thousands of people, who have been routed from their homes due to a natural or humanitarian disaster, need to be fed.

When cooking with stock pot over an open flame, the greatest amount of heat is produced and transferred to the stock pot at the point where the flame contacts the bottom of a stock pot. However, this also means that the greatest amount of heat is also transferred only on a limited area of the underside of the stock pot. In addition, because the flame is open and heated air rises, much of the resulting heat from the open flame is able to escape from underneath the stock pot and pass up along its sides. In tandem, these two inefficiencies lead to a significant amount of heat loss during the cooking process. In addition, the latter inefficiency introduces the lost heat into the kitchen or cooking space.

### SUMMARY OF THE INVENTION

The present invention is directed toward a stock pot cooker. The stock pot cooker comprises a firebox having a burner receptacle on a first side, a stock pot receptacle on a second side, and an exhaust port. Each of the burner receptacle, the stock pot receptacle, and the exhaust port are fluidically connected to a heat plenum formed within the firebox. The stock pot receptacle includes a seating surface configured to seat a stock pot of a predetermined size. When a stock pot having the predetermined size is seated, excess heat from the heat plenum is directed through the exhaust port.

Additional options may be incorporated into the stock pot cooker. As one option, the exhaust port may be disposed entirely below the seating surface. As another option, the stock pot receptacle may include at least two seating surfaces, with each seating surface being configured to seat stock pots having different predetermined sizes. As yet another option, a perforated barrier may be placed within the cooker to separate the stock pot receptacle and the exhaust port from the heat plenum. This perforated barrier may have a conical form. Any of the foregoing options may be implemented alone or in combination.

Accordingly, an improved stock pot cooker is disclosed. Advantages of the improvements will appear from the drawings and the description of the preferred embodiment.

### BRIEF DESCRIPTION OF THE DRAWINGS

In the drawings, wherein like reference numerals refer to similar components:

FIG. 1 illustrates a perspective view of a stock pot cooker; and

FIG. 2 illustrates sectional view of the stock pot cooker of claim 1 along the line 2-2.

### DETAILED DESCRIPTION OF THE PREFERRED EMBODIMENTS

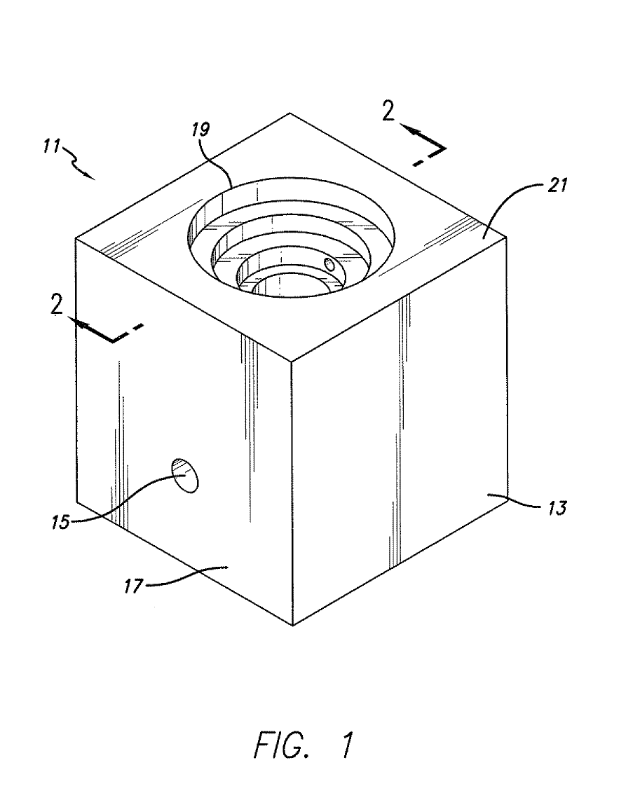

Turning in detail to the drawings, FIG. 1 illustrates the fire box 13 of a stock pot cooker 11 which is designed for improving the efficiency of cooking in a stock pot. The fire box 13 may be placed in a case and on a support frame as desired or as appropriate for a particular use. The fire box 13 is constructed from a low heat transfer and noncombustible material. Such materials are well known to those skilled in the relevant arts. The fire box 13 includes a burner receptacle 15 open onto the front side 17 and heated cavity forming a stock pot receptacle 19 open onto the top side 21. The burner receptacle 15 is adapted to receive the flame tube from a liquid fuel burner.

The liquid fuel burner (not shown) is preferably of the type generally described in U.S. Pat. No. 4,298,338, the disclosure of which is incorporated herein by reference in its entirety. Advancements in this type of liquid fuel burner may be found in U.S. Pat. No. 4,507,076 and U.S. Pat. No. 4,73,904, the disclosures of which are incorporated herein by reference in their entirety. Such liquid fuel burners are available from Babington Technology, of McLean, Va., and are advantageous because they can burn any distillate fuel efficiently and cleanly without smoke, odor, or carbon monoxide emissions. Alternatively, other types of heat generators may be used in conjunction with the stock pot cooker. Those skilled in the art will recognize that the heat output capabilities of the heat generator selected for use with the stock pot cooker will in large part determine the temperatures at which food within the stock pot may be cooked. Additional temperature sensors and controls may be added to the stock pot cooker, as desired, to control the heat output of the heat generator. Such sensors and controls are familiar to those skilled in the art, and as such, are not detailed further herein.

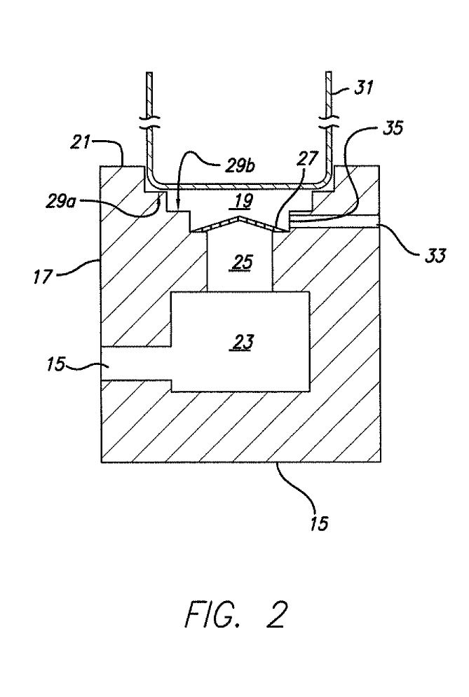

The interior of the fire box 13 is illustrated in FIG. 2. The burner receptacle 15 opens up into the heat plenum 23, where heat from the burner is collected and directed up through the duct 25 into the stock pot receptacle 19. A perforated barrier 27 separates the duct 25 from the stock pot receptacle 19. This perforated barrier 27 is curved or cone-shaped to better disperse heat rising from the duct 25 within the stock pot receptacle 19. As a matter of design preference, the perforated barrier 27 may have any geometrical configuration desired.

The stock pot receptacle 19 includes a plurality of seating surfaces formed as a series of shelves 29a, 29b, with each shelf being configured to seat a stock pot 31 having predetermined circumferential dimensions. When a stock pot is seated on one of the shelves 29a, 29b, the stock pot acts as a cover enclosing the stock pot receptacle 19. Other types and configurations of covers can be used to enclose the stock pot receptacle 19, thereby allowing the firebox to be used with a greater variety of cooking vessels.

With a stock pot 31 seated on the shelf 29a, little space is left between the side of the shelf 29a and the sides of the stock pot 31. The amount of space between the side of the shelf 29a and the side of the stock pot 31 is preferably less than one-quarter inch around the entire circumference of the stock pot 31, although as much as one-half inch of space, and even as much as one inch, may be incorporated into the design. Each shelf 29a, 29b included in the stock pot receptacle 19 is preferably similarly constructed, with the exception of circumferential dimension. An exhaust port 33 is included in a sidewall of the fire box 13 such that excess heat which builds up within the stock pot receptacle 19 is directed through the exhaust port 33 to the exterior of the fire box 13. The opening 35 of the exhaust port 33 within the stock pot receptacle is preferably positioned entirely below the lowest shelf 29b within the stock pot receptacle 19, although it may be positioned at least partially above the lowest shelf 29b. The location of the exhaust port ensures that even when a stock pot is seated on the lowest shelf 29b, excess heat is able to escape through the exhaust port 33.

At least a couple of advantages are presented by the stock pot cooker described above. One advantage is that heat is applied in a substantially even manner to the entire bottom surface of the stock pot. In addition, the stock pot is not directly exposed to any open flame, thereby eliminating a primary source of soot formation found in stock pot cookers of the prior art. A second advantage is that, unlike when a stock pot is placed on an open burner, excess heat is left with little or no room to escape around the bottom edge and up the side of the stock pot. Rather, excess heat is almost entirely directed through the exhaust port, because it is disposed beneath the bottom of the seated stock pot. Similarly, in stock pot cookers found in the prior art, the hot exhaust gases that are the products of combustion are free to rise along the side of the stock pot. In contrast, with the stock pot cooker described above, the emissions of hot exhaust gases can be entirely controlled and directed out of the firebox through the exhaust port. Thus, the exhaust gases can be kept entirely separated from the food being prepared. Another advantage is that with the stock pot in place, the combustion process takes place entirely within a confined space, thus reducing the amount of ambient noise resulting from the combustion process Still another advantage is that, during operation, the combination of forced convection aided by radiant heat and infrared emissions from the self-luminous (red hot) perforated barrier optimizes the heat transfer process. Those of skill in the art will recognize additional advantages presented by the above design.

Thus, a stock pot cooker is disclosed. While embodiments of this invention have been shown and described, it will be apparent to those skilled in the art that many more modifications are possible without departing from the inventive concepts herein. The invention, therefore, is not to be restricted except in the spirit of the following claims.

1. A stock pot cooker comprising:
a firebox having a burner receptacle on a first side, a stock pot receptacle on a second side, and an exhaust port, wherein each of the burner receptacle, the stock pot receptacle, and the exhaust port are fluidically connected to a heat plenum formed within the firebox, and the stock pot receptacle includes a seating surface configured to seat a stock pot having a predetermined size, such that when the stock pot is seated, excess heat from the heat plenum is directed through the exhaust port.

2. The stock pot cooker of claim 1, wherein the exhaust port is disposed entirely below the seating surface.

3. The stock pot cooker of claim 1, wherein the stock pot receptacle includes at least two seating surfaces, each seating surface being configured to seat stock pots having different predetermined sizes.

4. The stock pot cooker of claim 3, wherein the exhaust port is disposed entirely below the seating surfaces.

5. The stock pot cooker of claim 1, wherein the burner receptacle is configured to receive a burner assembly.

6. The stock pot cooker of claim 1, further including a perforated barrier disposed between the heat plenum, on one side, and the stock pot receptacle and the exhaust port, on the other side.

7. The stock pot cooker of claim 6, wherein the perforated barrier is cone-shaped.

8.-13. (canceled)

14. A cooking system comprising:
a stock pot;
a liquid fuel burner;
a firebox having a burner receptacle adapted to receive the liquid fuel burner on a first side, a stock pot receptacle on a second side, and an exhaust port, wherein each of the burner receptacle, the stock pot receptacle, and the exhaust port are fluidically connected to a heat plenum formed within the firebox, and the stock pot receptacle includes a seating surface configured to seat the stock pot, such that when the stock pot is seated, products of combustion from the liquid fuel burner are directed through the exhaust port, and when the stock pot is not seated, the products of combustion exhaust through the stock pot receptacle; and
a perforated barrier disposed between the heat plenum, on one side, and the heated cavity and the exhaust port, on the other side.

15. The stock pot cooker of claim 14, wherein the exhaust port is disposed entirely below the seating surface.

16. The stock pot cooker of claim 14, wherein the stock pot receptacle includes at least two seating surfaces, each seating surface being configured to seat stock pots having different predetermined sizes.

17. The stock pot cooker of claim 14, wherein the burner receptacle is configured to receive a burner assembly.

18. The stock pot cooker of claim 14, further including a perforated barrier disposed between the heat plenum, on one side, and the stock pot receptacle and the exhaust port, on the other side.

19. The cooking system of claim 18, wherein the perforated barrier is cone-shaped.
